(19) United States
(12) Patent Application Publication
(10) Pub. No.: US 2006/0004624 A1
(43) Pub. Date: Jan. 5, 2006

(54) Forecast and replenishment analytics

(76) Inventors: German O. Melara, Chicago, IL (US); Christine A. Fotteler, Winnetka, IL (US); Sylvia K. Ludwig, Saarbruecken (DE)

Correspondence Address: KENYON & KENYON, 1500 K STREET NW, SUITE 700, WASHINGTON, DC, 20005, US

(21) Appl. No.: 10/945,100

(22) Filed: Sep. 21, 2004

Related U.S. Application Data
(60) Provisional application No. 60/583,894, filed on Jun. 30, 2004.

(51) Int. Cl. G06Q 10/00

(52) U.S. Cl. 705/10

(57) ABSTRACT

The present invention includes methods, system, and apparatus. A method of the present invention may include collecting and storing replenishment data, calculating a performance indicator using the collected and stored replenishment data, transmitting the calculated performance indicator to a first database, flagging the calculated performance indicator within the first database with a searchable flag, sending a query to collect a calculated performance indicator and replenishment data, and obtaining a forecast and replenishment analytic calculation using the retrieved calculated indicator and replenishment data. An apparatus of the present invention may include a computer programmed to calculate analytics, the computer including a processor programmed to calculate a forecast and replenishment analytic using a calculated performance indicator and replenishment data retrieved from a database, the database storing calculated performance indicators and collected and stored replenishment data, and the calculated performance indicator stored within the database with a searchable flag.

### RELATED APPLICATION

This application claims the benefit of provisional application 60/583,894, filed on Jun. 30, 2004, and entitled “Retail Forecast Replenishment Engine.” That application is incorporated herein, in its entirety, by reference.

### FIELD OF THE INVENTION

The present invention regards the forecasting and replenishment of stock, merchandise or other materials on an occasional, periodic or ongoing basis. More specifically, the present invention regards the storage, retrieval, and use of raw and manipulated data to analyze a forecasting and replenishment process or system.

### BACKGROUND OF THE INVENTION

Contemporary retail businesses, such as retail organizations, retail stores, retail chains, and the like, perform strategic analysis, forecasting, and auto replenishment on selected and periodic bases in order to improve the efficiency and service levels of their organizations. These strategy and forecasting and auto replenishment systems may help manage future sales by predicting future throughputs and quantifying the orders necessary to replenish depleted stocks. The analysis, forecasting and auto replenishment that these systems may carry out can also include: 1) predicting the quantity and profit margin for sales that occur over a specific period of time; and 2) calculating the demand periods when product will be needed. When these systems or processes are optimized, businesses may be better positioned to improve profits, increase efficiencies, and reduce waste.

As to specific genres of businesses, a retail mail order company may use forecasting and auto replenishment systems to stock the minimum amount of product necessary to supply anticipated demand, thereby reducing carrying costs, warehousing costs, and increasing customer satisfaction. As to brick and mortar retailers, a properly run forecast and auto replenishment system can ensure that shelves are stocked with the appropriate merchandise to enhance sales and meet customer demand. Moreover, low demand items are not over bought, minimizing purchase of slow turnover items and their accompanying large storage costs and high return stock burdens. In each case, the profitability of a business may be optimized and the business process may be run more efficiently when an accurate forecast and auto replenishment system is employed.

### BRIEF DESCRIPTION OF THE DRAWINGS

FIG. 1 is a flow chart of a forecast and auto replenishment process that may be employed in accord with the present invention.

FIG. 2 is a schematic of a database containing a plurality of records as may be employed in the present invention.

FIG. 3 is a schematic illustrating calls that a processor may make to an analytic function table and database in accord with the present invention.

FIG. 4 is a schematic of a computing system that may be employed in accord with the present invention.

FIG. 5 is a schematic of components that may communicate over a wide area network in accord with the present invention.

### DETAILED DESCRIPTION

The present invention regards methods, systems, and apparatus that may be used to complete or modify a forecast and auto-replenishment system. In accord with the present invention, after querying a functions table for the definition of one or more functions needed to satisfy a user's query, a processor may extract both raw and calculated data to complete the calculation identified by the functions retrieved from the function table. Through the storage of raw and calculated data the amount of stored information, which can be significant if only raw data is stored, may be greatly reduced without substantially compromising the ability to analyze a forecast or real time sales outcome from various fundamentals or areas of business interest. Data stored in these databases may be flagged with multiple markers in order to allow it to be searched with various criteria.

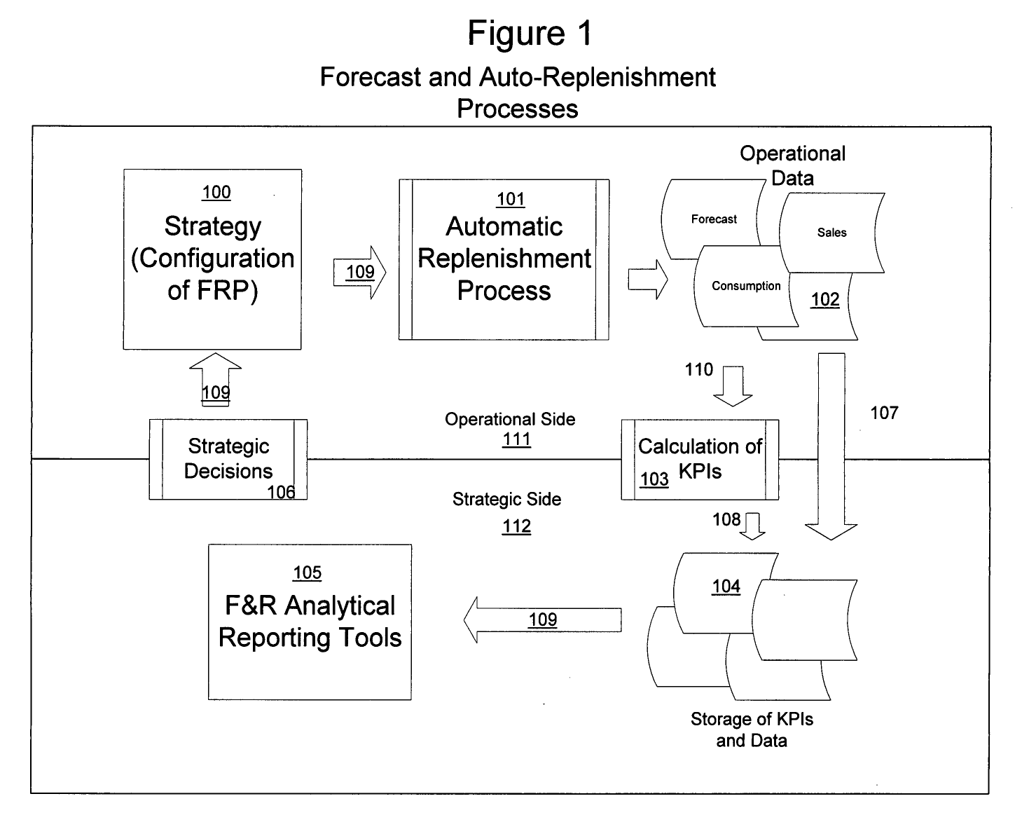

FIG. 1 is a flow chart showing various steps and processes that may be carried out and undertaken in accord with the present invention. These steps and processes are depicted as either taking place on the operational side 111 of the system and on the strategic side 112 of the system with a few steps actually bridging between the two sides. The steps that take place on the operational side of the system may be considered to involve day to day gathering of business data while those taking place on the strategic side may be considered to involve the analysis and subsequent forecasting using this data. The delineation of sub-tasks within the itemized steps are not hard and fast as certain sub-steps within each of the itemized steps may be performed in other itemized steps of the system as well.

The forecast and replenishment process of FIG. 1 may be an iterative process or method that may start and finish with the creation or modification of a forecast and auto replenishment business strategy at Strategy (Configuration of FRP) 100. This strategy may be industry and business specific and may include predicting the level of inventories that must be maintained, predicting the speed at which these inventories must be replenished, predicting or estimating the cost at which it is profitable to replenish these inventories, and estimating the lead times associated with particular products. This strategy may also include various other factors depending upon the business and retail industry being managed. Thus, identifying which factors may be measured and setting the operational targets for each of these factors may both be carried out at step 100.

Once defined at step 100, the basic measurables for forecasting and auto replenishing stock may then be monitored and measured during step 101. The measuring and monitoring may be carried out automatically or manually. The automatic collection may include quantifying sales data and determining inventory levels with scanning equipment. The manual collection of data may include visual inspections and regular weighing or counting of stock. For both manual and automatic systems, wired and wireless networks may be employed to assist in collecting the data, storing the data or both.

The data collected in step 101 may then be categorized and stored as operational data in step 102. This operational data may be sub-categorized or flagged in order to provide more efficient tabulation and access to it. This sub-categorization or flagging may include classifying the data as forecast data as well as sales data. Other sub-categories may be used as well depending upon the particular needs of the business. The sales data may include volume and cost, while the forecast data may include date of presumed consumption and presumed target consumer group. Furthermore, the forecast data may also be some blend of this information as well as other types such as existing stock, stock on hand at time of sale, and equivalent sales from a prior year or other past period of time. UPC or other codes may be used to simplify the gathering and storage of this data. Thus, as the business is run, the data may be collected and stored at step 102 for subsequent analysis and use.

The operational data 102 may be stored on a daily, weekly or other convenient basis depending upon business factors and the user's specific input. Moreover, to restrict the data buying stored in the database, the original effective data at 102 may be filtered prior to being sent via arrow 107 to the database 104. This may include time filters, as well as skipping filters wherein only the third or fourth piece of data for any particular product would be sent with the other three being discarded prior to reaching the database.

As noted, the data at 102 may be stored with various searchable flags or indices such that it may be easily transmitted, parsed out, and searched. These flags may include indices that permit the data to be sorted or searched by week, day or some other period. There may be other indices as well. These indices may include store location, inventory level, date of sale, time of sale, and MRP controller. The indices chosen should be tailored to satisfy the particular needs of the business.

After the operational data is stored and flagged at 102, it may then be transmitted, as shown by arrows 107 and 110, to either step 103, which is where Key Performance Indicators (“KPIs”) may be calculated or to step 104, where the data may be stored in a database for subsequent query. The KPIs that may be calculated at step 103 may be a specific industry standards or any general KPIs that address generally known retail performance indicators such as gross sales, net sales, average service levels, and sales per day. The particular KPIs to be calculated may be identified at step 100 as the strategy is initially developed or may be subsequently added as the process is modified and honed. Once the KPIs are calculated at step 103 they may be sent to and stored in database 104. The flow of the KPIs to the database 104 is shown with arrow 108.

Like the operational data at 102, the data within the database 104 may be stored in records that may contain various indices or flags that allow the data to be searched and queried in a multi-dimensional fashion. In other words, the same data may be responsive to various searches and queries. The indices and flags used may include location address, product name, product color, and cost of inventory as well as innumerable other flags that may be necessary for a particular business or strategy.

Once the raw and analyzed data is stored in the database 104, analytical tools at 105 may be used to analyze it. These analytical tools may be predefined algorithms, processes or steps that may query the database 104 and retrieve or analyze responsive data in the database 104. These queries may use both the calculated data stored in the database as well as the raw operational data stored there. Thus, as the analytics may be used as often as necessary, the analysis they provide can show results on a real-time or near real-time basis.

Once the data is analyzed at 105, and the results of the current strategy are considered, a user may choose to run additional reports and conduct additional analysis, make strategic decisions at step 106, or perhaps complete both steps or take some other measures.

If adjustment is warranted, the strategy that was initially set at 100 may be modified. Thus, an iterative process is created whereby a strategy is first laid out, is then carried out, and then, depending upon the outcomes of that particular strategy, improved, honed, modified or changed to optimize the operation of a business.

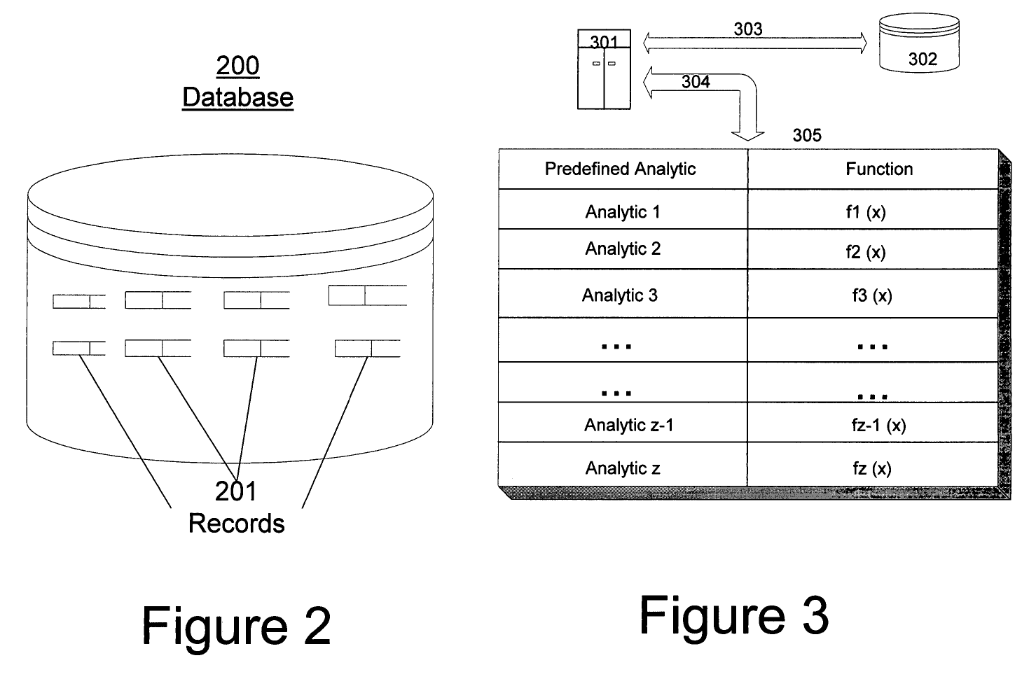

FIG. 2 is an enlarged view of a database 200 that may be employed in the current invention. This database 200 may be used at step 102 or 104 as it may contain a plurality of individual records 201 that may be searched in various ways. In other words each of the records may contain one or more searchable flags or indices that allow it to be allocated to one or more particular categories. Thus, the data, which can provide information as to various categories, need only be stored once as it can be recalled under different and numerous query flags.

For example, when sales of a particular product at a given location are known, this data may be searched to provide information regarding total sales at that location, total sales of that particular product across numerous locations, and total sales for that product for a given period of time. It may be searched for other reasons as well. In so doing, the amount of raw data stored in the database is minimized, as data needed to solve the analytics can be located based on the flags assigned to the data records, thereby making the searches more efficient and quicker.

As mentioned in the discussion of FIG. 1, some of the records 201 in database 200 may contain raw data while others may contain calculated data, such as KPIs. Some records may also contain a combination of raw and calculated data.

FIG. 3 shows a processor 301, database 302, and function table 305 that may be used in accord with the present invention. In use, a user may choose one or more analytics from a predefined list of analytics in order to analyze the performance of an ongoing F&R strategy. The particular analytics provided may depend upon the retail industry and may include those defined herein, as well as others. A user may chose from the list of analytics and may provide additional parameters under which these analytics may be run. For instance, if a user wishes to run an overstock report, the user may specify one or more variables including the geographic region in which the report will apply to, the product to be evaluated, and the time frame over which the overstocks should be considered. Once chosen, a processor 301 may be used to query a function table 305 in order to retrieve the functional definition of the requested analytic. The processor 301 may then review the definition of the function and the chosen user parameters and may compose and send a query to a database 302 in order to extract the specific raw and processed data required to solve the chosen function under the identified parameters. Consequently, the processor's query of the database 302 is often unique, even for identical functions, as the query may not only depend upon the analytic but also upon the variables elected by the user. Once the function is solved, the processor 301 may output the results back to the user.

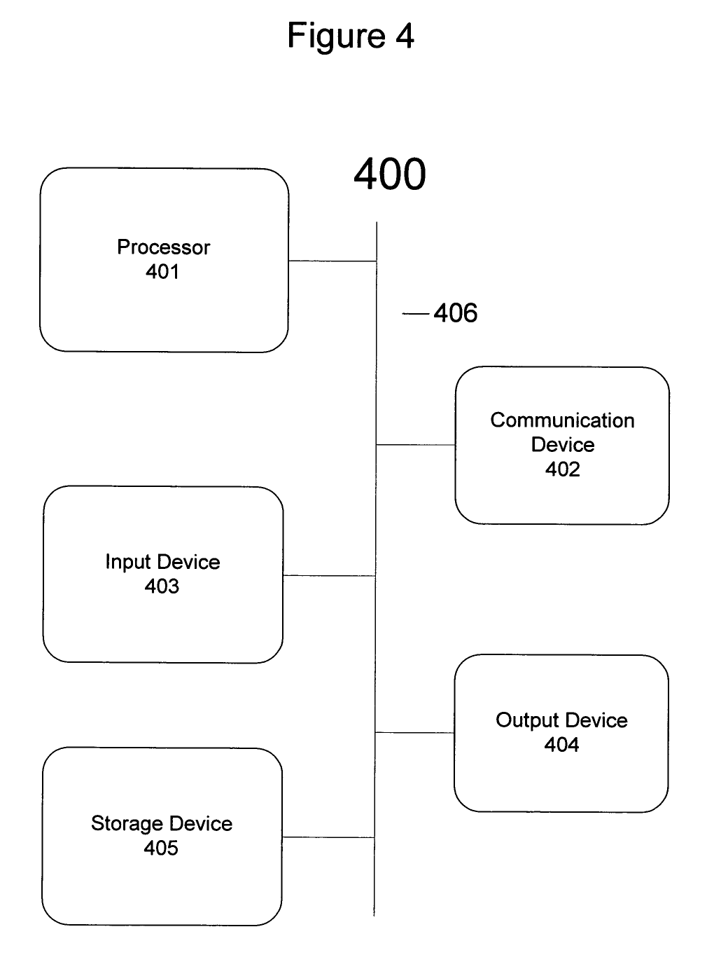

FIG. 4 is a schematic of a computer that may be used in accord with the present invention. In the computer of FIG. 4 a main bus 406 may be used to link a processor 401, a communication device 402, an input device 403, an output device 404, and a storage device 405. This computer 400 may be used as a work terminal running the analytics of the present invention, as a device for communicating over a wide-area network, and as a server that stores the data, both raw and calculated, and outputs the data depending upon a specific user's queries. This computer may run these processes from both non-volatile and volatile memory. Likewise, the instructions that the computer carries out may be stored or run from transportable media such as magnetic disks, magnetic tapes, and CD-ROMs.

In one example, the storage device 405 may store the operational data 102 from FIG. 1 as well as the stored KPIs and Data 104 in FIG. 1. The processor 401 may access the data at 102 in order to calculate the KPIs at 103, which may then be stored in the storage device 405. The processor 401 may also access the data at 104 in order to perform the analytics identified in step 105. In this case, a user may provide inputs through communication device 402, in order to command the processor to run several of the predefined analytics at 105. Upon receiving these commands, the processor 401 may access the storage device 405 and may carryout the requested calculations. In addition to being output to a user, the results may also be stored in storage device 405 and may be output, through output device 404, to other devices across a network. The processor 401 may also receive instructions from input device 403. These instructions may include instructions to carryout any of the various steps or methods described herein as well as sub-steps or portions of the various steps or methods described herein. Likewise, the computer 300 may work in conjunction with other computers over a network in order to store the requisite information and carryout the requisite steps described herein.

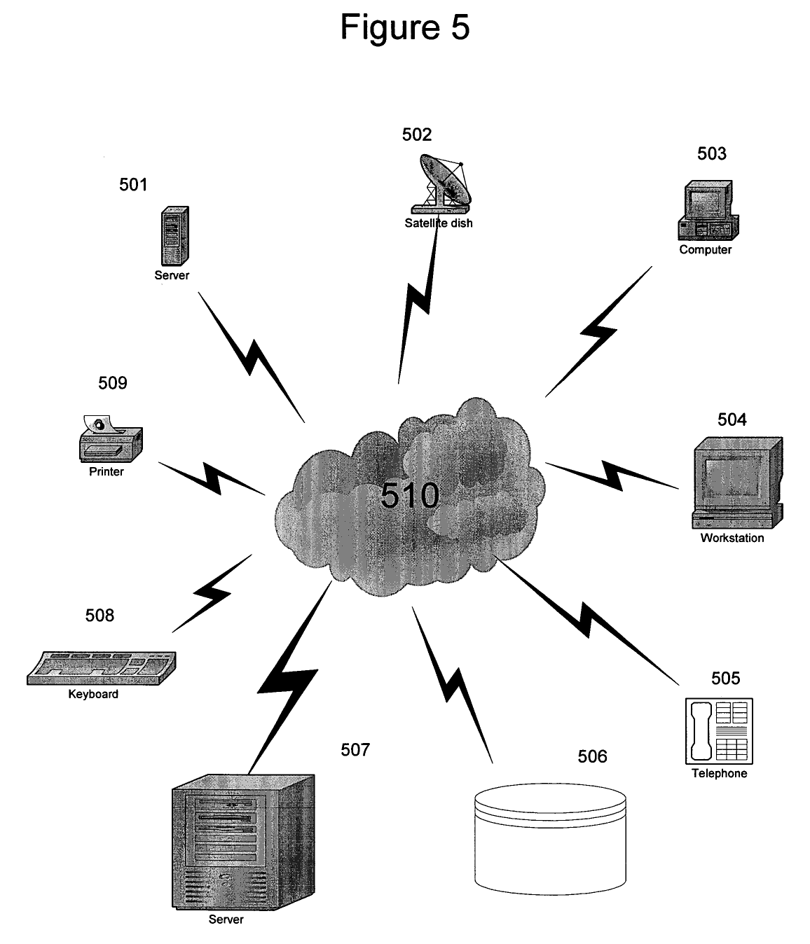

FIG. 5 is a schematic of a network with peripherals that may be employed in the current invention. In this embodiment, a wide-area network 510 may serve to connect a server 501, satellite dish 502, computer 503, work station 504, telephone 505, database 506, server 507, keyboard 508, and printer 509. This wide-area network may connect other peripherals as well. The peripherals in FIG. 5 may perform various functions in this and other embodiments.

The work station 504 and computer 503, may each serve as input and output stations for a user wishing to input data and perform forecast and auto replenishment queries. For instance, a user wishing to determine how efficient certain strategies are may use a computer or terminal to pose specific queries to the database 506. In carrying out these queries, the user may be prompted by a script that describes or identifies certain analytics that may be run over the network. After, perhaps, entering a PIN or a password, the user may then run certain analytics by following the script. Certain output data may be provided to the user. Output data may also be output to a printer or a workstation. A user may also use the workstation 504 or computer 503 to query the database and run the desired analytics in these and other embodiments.

The network may be used to link various retailers that need to access the database 506. In so doing, the database can receive information from multiple sources across very large geographic areas. Printer 509 may serve as an output for printing reports, and keyboard 508 may be used for real time entry of data, as well as to query the database using the various analytics described herein.

Various predefined analytic reports that may be stored in the F&R analytical tools mode may be stock exception reports such as under-stocks, over-stocks, stock-outs, lost sales for stores and undelivered products for distribution centers. Other analytic reports may include stock development reports, service level development reports, range of coverage factor development reports, and dead stock reports. Still further reports may include forecast reports, stability reports, and manual intervention reports.

An under stock report may allow a user to analyze past situations in which a stock level fell below lowest user defined percentage of a minimum stock level. The minimum stock level may be one of the strategies set during step 106. An over stock report may show the user situations in the past where the stock level was higher than a predefined maximum stock level. The over stock report may be a valuable tool that allows a planner to obtain information on the amount of extra stock holdings for particular products and locations. This report, in conjunction with the stock out report, may aid the planner in the evaluation, the cost of stock holding versus the cost of lost sales.

A stock gap lost sales report may show lost sales that are related to stock outs.

A maximum stock level analytic may be the maximum volume of product that may be presented in a shelf or stored. By considering this report, a user may discover high stock situations for given dates and product location combinations.

A forecast quality report may measure the quality of forecasts and the actual consumption of units versus the forecast consumption of units. This report may show all consumption data even if there is no difference between the consumption and the forecast of consumption. For instance, Monday through Thursday periods and Wednesday through Friday periods may both be compared in this report. Furthermore, the consumption for certain periods of time may also be compared against forecasts for different periods of time. In other words, three day periods may be compared to other three day periods as well as to other five, seven, and ten day periods.

A manual change order report may show the frequency, scale, and eventual consequences of manual changes made in automatically created order proposals. In this report a manual change of proposal quantity may be compared with the automatically generated order proposal quantities.

A level of automation report may show the number of generated order proposal line items and the proportion of the order proposal line items that could be released automatically.

A replenishment exception report may provide a user an overview of the quantity, frequency, and types of different exception reports by the replenishment and forecasting process over a period of time.

A variance and dynamic versus static minimum stock report may also be run. This report may compare the calculated dynamic minimum stock with the static minimum stock. The comparison may show how much the static minimum stock differs from the dynamic minimum stock and they also aid the user in violation of the statically defined minimum stock. A dynamic minimum stock may be calculated during a replenishing process and may help the user know whether the static minimum stock is quickly defined or should be checked.

A service level development report may show the development of the service levels for product location combination or hierarchical level for a given period of time.

A range of coverage development report may show the fluctuation of the range of coverage for product location combination or hierarchical level for a given period of time. It makes sure the range of coverage in periods that are covered by the stock situation, the range of coverage, the range of coverage factor and the mean values for all these key figures.

A dead stock report may show all the distribution centers and product combinations where stock is greater than zero and those that existed for several months in the past. A user may request a number of months that the report should check in the past with the default of twelve months being defined for the report.

A case report, which may be a subset of a dead stock report, may be used to aid the replenishment specialist to decide if the product should be discontinued or marked down in order to remove it from existing stock.

Throughout this method and system there may be various preferred requirements to further expedite the processing and handling of data. For one, it may be preferable that the sales price and storage costs should be available in currency amounts and the currency in which this information is stored should be available such that it can be converted easily. For another, replenishment data may preferably be made available in data slices as small as a twenty four hour period.

The various steps and embodiments of the present invention are exemplary and should not be seen as limiting. Moreover, steps undertaken in one embodiment may be completed in others. Still further, steps may be skipped and undertaken out of order while also remaining within the spirit and scope of the present invention. Thus, the claims themselves should be used to delineate the breadth of the current invention.

What is claimed is:

1. A method of monitoring, forecasting, and replenishing an inventory comprising:
collecting and storing forecasting and replenishment data;
calculating a performance indicator using the collected and stored replenishment data;
transmitting the calculated performance indicator to a first database;
flagging the calculated performance indicator within the first database with a searchable flag;
sending a query to collect a calculated performance indicator and replenishment data;
obtaining a forecast and replenishment analytic calculation using the retrieved calculated indicator and the forecast and replenishment data.

2. The method of claim 1 wherein the forecast and replenishment data is stored in a database.

3. The method of claim 1 wherein the forecast and replenishment data and the calculated performance data is stored in the same database.

4. The method of claim 1 further comprising:
sending portions of the collected and stored forecasting and replenishment data to the database.

5. The method of claim 1 wherein collecting the forecast and replenishment data includes performing a filter step to exclude certain pre-selected categories of replenishment data.

6. The method of claim 1 further comprising:
updating a forecasting and replenishment strategy using the calculation from the forecast and replenishment analytic.

7. The method of claim 1 further comprising:
developing a forecast and replenishment strategy.

8. The method of claim 1 wherein the forecast and replenishment analytic has been chosen from a list of forecast and replenishment analytics.

9. A computing memory device that provides instructions for use by a computer to carry out a method of monitoring, analyzing, and evaluating forecasting and replenishment data comprising:
collecting and storing replenishment data;
calculating a performance indicator using the collected and stored forecast and replenishment data;
transmitting the calculated performance indicator to a first database;
flagging the calculated performance indicator within the first database with a searchable flag;
sending a query to collect a calculated performance indicator and replenishment data;
obtaining a forecast and replenishment analytic calculation using the retrieved calculated indicator and replenishment data.

10. The memory device of claim 9 providing further instructions wherein the forecast and replenishment data is stored in a database.

11. The memory device of claim 9 providing further instructions wherein the forecast and replenishment data and the calculated performance data is stored in the same database.

12. The memory device of claim 9 providing further instructions comprising:
sending portions of the collected and stored forecast and replenishment data to the database.

13. The memory device of claim 9 providing further instructions wherein collecting the forecast and replenishment data includes performing a filter step to exclude certain pre-selected categories of replenishment data.

14. The memory device of claim 9 providing further instructions comprising:
updating a forecasting and replenishment strategy using the calculation from the forecast and replenishment analytic.

15. The memory device of claim 9 providing further instructions comprising:
developing a forecast and replenishment strategy.

16. The memory device of claim 9 providing further instructions wherein the forecast and replenishment analytic has been chosen from a list of forecast and replenishment analytics.

17. A computer programmed to calculate analytics for a method of forecasting and replenishing, the computer comprising:
a processor;
a data input;
a data output;
and a storage device,
the processor programmed to query a function table containing a list of predefined functions and retrieve from that table on or more of the functions,
the processor further programmed to identify the variables needed to solve the retrieved function and to prepare a second query to retrieve the identified variables from a database,
the processor further programmed to send the second query to the database and to receive the identified variables, the variable consisting of at least raw data and previously calculated data, and
the processor further programmed to use the raw data and the previously calculated data to solve the function retrieved from the function table and to output a solution.

18. The computer of claim 17 wherein the storage device buffers the instructions to execute at least one analytic from a list of analytics.

19. The computer of claim 17 wherein the processor is programmed to allow a user to select the function to be solved by the processor from a list of forecasting and replenishment analytics.

20. The computer of claim 17 wherein the processor is programmed to provide a solution across a wide area network.

21. The computer of claim 17 wherein the processor is programmed to send an update instruction to amend the list of functions in the function table.

22. A method of providing analysis of retail sales comprising:
collecting raw retail sales data;
storing portions of the raw retail sales data in a searchable database;
solving a first function from a first list of functions using some of the collected retail sales data;
storing solutions from the solved functions in the searchable database;
querying the searchable database to obtain raw retail sales data and solutions stored in the searchable database; and
using the retrieved solutions and raw retail sales data to solve a second function.

23. The method of claim 22 wherein the second function to be solved is chosen by a user and wherein the user has identified one or more of variables within the second function to be solved.

24. The method of claim 22 wherein the second function is chosen from a list of second functions.

25. The method of claim 22 wherein each query is generated by a computer.

26. The method of claim 23 wherein the variables are chosen from list comprising:
product name, date of sale, price of sale, location of sale, and product size.
